(19) United States
(12) Patent Application Publication
(10) Pub. No.: US 2023/0331279 A1
(43) Pub. Date: Oct. 19, 2023

(54) CONVERTIBLE STROLLERS

(71) Applicant: Baby Jogger, LLC, Atlanta, GA (US)

(72) Inventors: Jordi Dorca Pujol, Sant Joan de les Abadesses (ES); Rachel Holt, Roswell, GA (US); Megan Cahill Roe, Roswell, GA (US)

(21) Appl. No.: 18/295,044

(22) Filed: Apr. 3, 2023

Related U.S. Application Data
(60) Provisional application No. 63/363,163, filed on Apr. 18, 2022.

(51) Int. Cl. B62B 9/14; B62B 7/12; B62B 9/10; B62B 7/04

(52) U.S. Cl. CPC B62B 7/126; B62B 7/044; B62B 9/102; B62B 9/142

(57) ABSTRACT

A convertible stroller assembly may be convertible between a stroller configuration and a trailer configuration. The assembly includes a stroller frame including a pair of laterally opposed hubs. The assembly further includes a plurality of wheels coupled to the stroller frame and including at least one removable front wheel. The assembly further includes a seat frame adjustably coupled to the stroller frame. The seat frame is adjustable relative to the pair of laterally opposed hubs between a first position and a second position lower than the first position. The assembly is convertible between (i) a stroller configuration in which the front wheel is coupled to the stroller frame and the seat frame is in the first position, and (ii) a trailer configuration in which the front wheel is absent and the seat frame is in the second position having a lower center of gravity than the first position.

### CROSS-REFERENCE TO RELATED APPLICATION

This application claims the benefit of U.S. Provisional Application No. 63/363,163, filed Apr. 18, 2022, the entirety of which is hereby incorporated by reference.

### TECHNICAL FIELD

The present disclosure relates generally to strollers, and in particular, to convertible strollers.

### BACKGROUND

Strollers may be used to seat children for travel or leisure. While strollers may be pushed by a person walking behind the stroller, strollers may also be propelled by a person who is running or jogging. Instead of being pushed, strollers may also be pulled, for example, as a trailer by a bicycle.

A need remains for strollers that can be used for different purposes, and which are convertible for various uses.

### SUMMARY

The present disclosure describes strollers, and in particular, convertible strollers.

In embodiments, the present disclosure describes a convertible stroller assembly that is convertible between a stroller configuration and a trailer configuration. The assembly includes a stroller frame including a pair of laterally opposed hubs. The assembly further includes a plurality of wheels coupled to the stroller frame and including at least one removable front wheel. The assembly further includes a seat frame adjustably coupled to the stroller frame. The seat frame is adjustable relative to the pair of laterally opposed hubs between a first position and a second position lower than the first position. The assembly is convertible between (i) a stroller configuration in which the front wheel is coupled to the stroller frame and the seat frame is in the first position, and (ii) a trailer configuration in which the front wheel is absent and the seat frame is in the second position having a lower center of gravity than the first position.

### BRIEF DESCRIPTION OF THE DRAWINGS

FIG. 1A is a conceptual perspective view of a convertible stroller assembly in a stroller configuration.

FIG. 1B is a conceptual side view of the stroller assembly of FIG. 1A.

FIG. 1C is a front side view of the stroller assembly of FIG. 1A.

FIG. 1D is a top view of the stroller assembly of FIG. 1A.

FIG. 2A is a conceptual perspective view of the convertible stroller assembly of FIG. 1A in a trailer configuration.

FIG. 2B is a conceptual side view of the stroller assembly of FIG. 2A.

FIG. 2C is a front side view of the stroller assembly of FIG. 2A.

FIG. 2D is a top view of the stroller assembly of FIG. 2A.

FIG. 3 is a conceptual perspective view of a stroller including the convertible stroller assembly of FIG. 1A in a stroller configuration.

FIG. 4 is a conceptual perspective view of a trailer including the convertible stroller assembly of FIG. 1A in a trailer configuration.

FIG. 5 is a bottom perspective view of a front frame assembly of the stroller assembly of FIG. 1A.

FIG. 6 is a top perspective view of the front frame assembly of FIG. 5.

FIG. 7A is a top perspective view of the front frame assembly of FIG. 5.

FIG. 7B is a perspective view of the front frame assembly of FIG. 5 and a hatch bar.

FIG. 8 is another conceptual perspective view of the convertible stroller assembly of FIG. 1A in a trailer configuration.

FIG. 9 is a bottom perspective view of a front frame assembly of the stroller assembly of FIG. 5 in a trailer configuration.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The present disclosure describes stroller assemblies that are convertible for different uses. For example, a stroller assembly may be convertible between a walking or jogging mode and a trailer mode, for example, for use with a bicycle.

Certain strollers may be convertible into trailers. However, such strollers may have limited functionality as a trailer, because they may not be able to adjust the center of gravity for sufficient stability.

Stroller assemblies according to the present disclosure may allow changes in the center of gravity in different modes of use, and thus have relatively high stability in both a trailer mode and a stroller mode. Further, stroller assemblies according to the present disclosure may be relatively more compact, or be more amenable to manufacturing, or relatively simple to convert and use in different modes.

In embodiments, the present disclosure describes a convertible stroller assembly that is convertible between a stroller configuration and a trailer configuration. The assembly includes a stroller frame including a pair of laterally opposed hubs. The assembly further includes a plurality of wheels coupled to the stroller frame and including at least one removable front wheel. The assembly further includes a seat frame adjustably coupled to the stroller frame. The seat frame is adjustable relative to the pair of laterally opposed hubs between a first position and a second position lower than the first position. The assembly is convertible between (i) a stroller configuration in which the front wheel is coupled to the stroller frame and the seat frame is in the first position, and (ii) a trailer configuration in which the front wheel is absent and the seat frame is in the second position having a lower center of gravity than the first position.

Thus, the occupant may be seated in a higher position in the stroller mode, and in a lower position in the trailer mode. The shift in weight of the occupant may provide shifts in center of gravity, and thus the stroller may provide adequate stability in both the jogger and trailer mode.

In embodiments, stroller assemblies include a rear frame assembly, a front frame assembly, and a handle articulated about a pair of laterally opposed hubs. The seat frame may be secured to the rear frame assembly, and may slide along the rear frame assembly between two different positions. The rear frame assembly may include respective detents, tabs, or locks to stably hold the seat frame in each position. In some embodiments, the seat frame may not be slidable, and instead, be fixedly secured by removing and remounting at each distinct position.

The stroller may be foldable, for example, by relative rotation about the hubs of portions of the stroller frame. For example, the stroller may be folded for storage in the stroller mode.

When used in the trailer mode, for example, by removing the front wheel, the center of gravity may be adjusted to provide more stability. For example, the seat frame be lowered.

The stroller assembly may further include a canopy bar to hold a canopy, and the canopy may be foldable. In some embodiments, the canopy is foldable in the stroller mode, but fixed in the trailer mode to provide additional protection to the occupant in the trailer mode.

The front wheel is removable. In some embodiments, the wheel may be stowed on a rear or side storage area or storage clip in the trailer mode. The stroller assembly may further receive a hitch from a bicycle, for example, at a front portion or a front hub.

The handle may be adjustable or foldable, and may provide extra protection for an occupant’s body or head, for example, when the seat is in a lower position.

Thus, stroller assemblies according to the present disclosure are convertible between a stroller mode and a trailer mode, without substantially departing from the functions provided by a stroller. Stroller assemblies according to the present disclosure may be relatively more flexible, light, and compact as compared to conventional strollers or trailers.

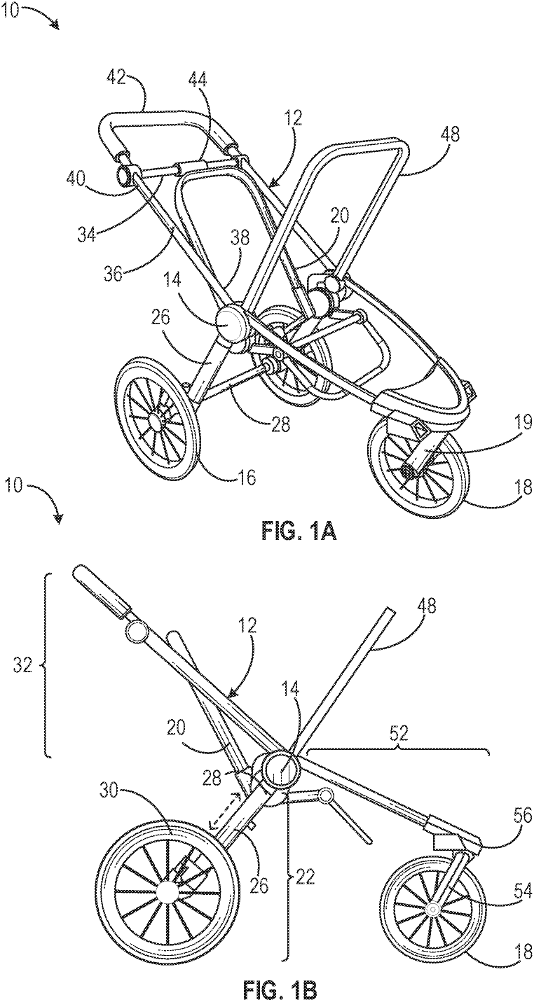

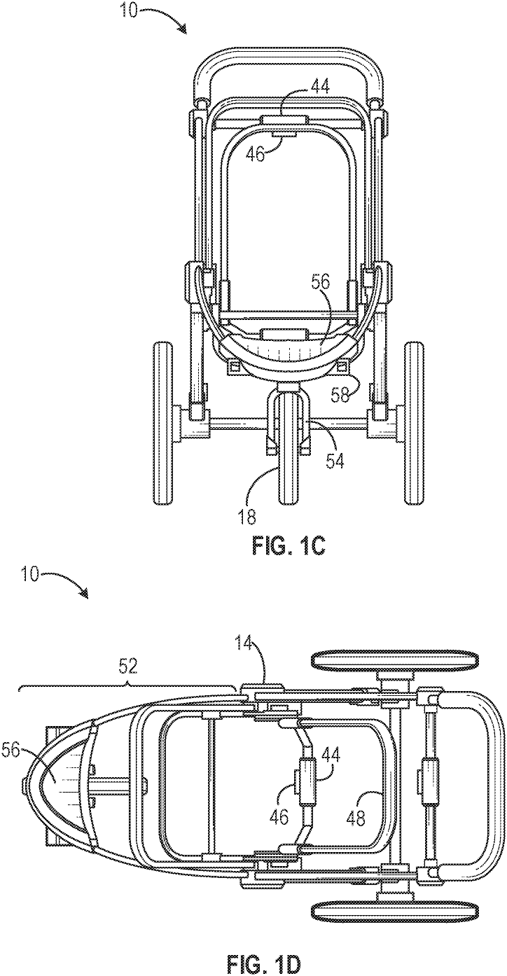

FIG. 1A is a conceptual perspective view of a convertible stroller assembly 10 in a stroller configuration. FIG. 1B is a conceptual side view of the stroller assembly 10 of FIG. 1A. FIG. 1C is a front side view of the stroller assembly 10 of FIG. 1A. FIG. 1D is a top view of the stroller assembly 10 of FIG. 1A.

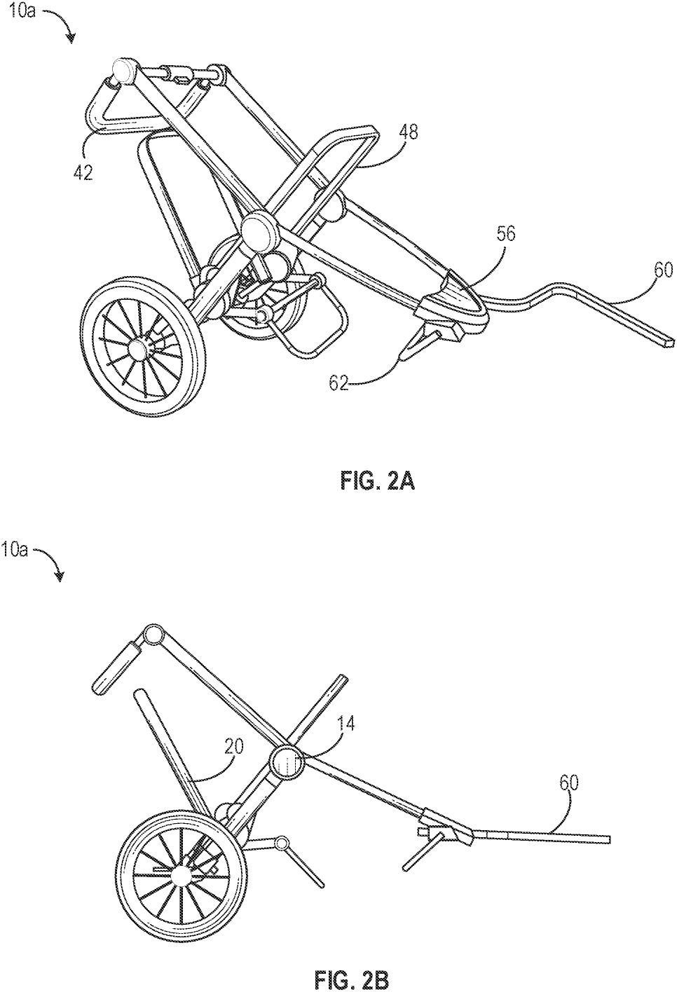

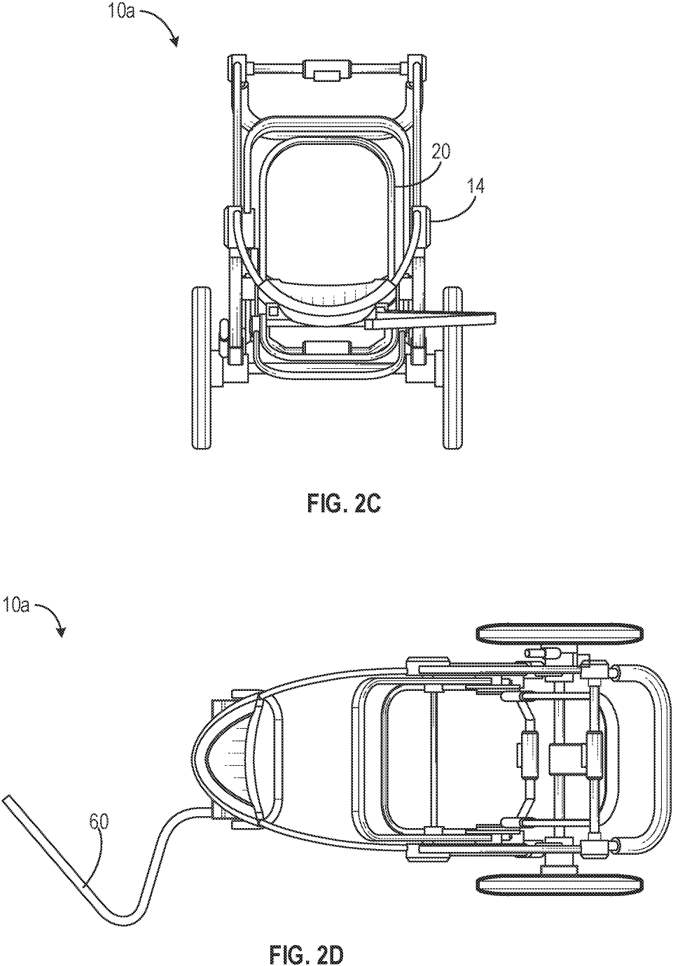

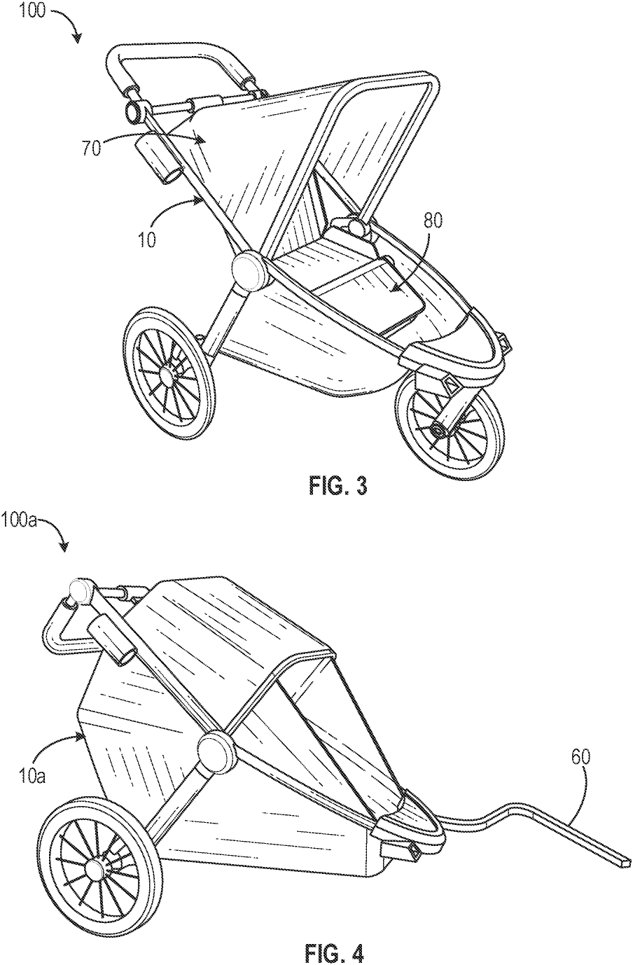

The convertible stroller assembly 10 is convertible between a stroller configuration (shown in FIGS. 1A to 1D) and a trailer configuration (shown in FIGS. 2A to 2D). The assembly 10 includes a stroller frame 12 including a pair of laterally opposed hubs 14.

The stroller frame 12 may be formed of one or materials, for example, a metal, an alloy, a plastic, a carbon-fiber, a composite material, or combinations thereof. The hubs 14 may be formed of one or more materials, for example, a metal, an alloy, a plastic, a carbon-fiber, a composite material, or combinations thereof. In some embodiments, the stroller frame 12 is formed of an alloy, and the hubs 14 are formed from plastic.

The hubs 14 may be formed as left-right mirrored pairs, for example, with corresponding openings, edges, surfaces, or contours. In embodiments, the hubs 14 are formed as substantially cylindrical shells, with one end of the respective cylinder being closed, and another end being open. For example, the closed ends of the hubs 14 may face outward, while the open ends may face inward, for example, to receive one or more components of the assembly 10.

In some embodiments, one or more portions or ends of the stroller frame 12 are received by corresponding windows, openings, slots, or tabs, defined in hubs 14. In some embodiments, the hubs 14 may be rigid, but have some give or flexibility, to allow limited or defined relative movement between components of the assembly 10, for example, to permit folding and unfolding of the assembly 10.

To facilitate a description of the convertibility of the assembly 10, only substantially structural components are shown in FIGS. 1A to 1D. Elements used to finish the stroller assembly into a stroller are not shown in FIGS. 1A to 1D, but it will be understood that the structural components may be covered with appropriate materials, liners, foams, netting, webs, fabrics, padding, or other finishing elements.

The assembly 10 further includes a plurality of wheels 16 coupled to the stroller frame 12 and including at least one removable front wheel 18. The plurality of wheels 16 (including the front wheel 18) may be formed of any suitable material or combinations of materials. In some embodiments, the assembly 10 includes no more than two rear wheels and one front wheel 18. In other embodiments, the assembly 10 includes more than two rear wheels and more than one front wheel 18. In some embodiments, the assembly 10 includes only one rear wheel and two front wheels 18. In some embodiments, the front wheel 18 is laterally centered relative to two outer rear wheels, for example, like a tricycle.

Wheels of the plurality of wheels 16 positioned at a rear of the stroller may not be removable. For example, the rear wheels may not be removable by a user without the use of tools or without damaging the stroller assembly 10. The front wheel 18 may be removable and couplable by a user, for example, without disassembling the assembly 10, or without requiring specialized tools or equipment, or without damaging the stroller assembly 10. In some embodiments, the user 10 may be required to use a tool such as a hex wrench, screw driver, or some other tool to safely couple and remove the front wheel 18 to and from the stroller frame 12.

In embodiments, each hub of the pair of laterally opposed hubs 14 is between the at least front wheel 18 and the at least two rear wheels in a direction from the at least front wheel to the at least two rear wheels. In some embodiments, each hub of the pair of laterally opposed hubs 14 is offset from a geometric center between the at least front wheel 18 and the at least two rear wheels in a direction toward the at least two rear wheels. For example, the hubs 14 may be closer to the rear wheels of the plurality of wheels 16 than to the front wheel 18.

The assembly further includes a seat frame 20 adjustably coupled to the stroller frame 12. The seat frame 20 is adjustable relative to the pair of laterally opposed hubs 14 between a first position (shown in FIGS. 1A to 1D) and a second position lower than the first position (shown in FIGS. 2A to 2D). For example, the seat frame 20 may be removed from one of the first or the second positions and re-coupled in another of the first or second positions. In some embodiments, the seat frame 20 is slidably coupled to the stroller frame 12, and is slidable relative to the pair of laterally opposed hubs 14 between the first position and the second position lower than the first position.

The assembly 10 is convertible between (i) a stroller configuration in which the front wheel 18 is coupled to the stroller frame 12 and the seat frame 20 is in the first position (shown in FIGS. 1A to 1D), and (ii) a trailer configuration in which the front wheel 18 is absent and the seat frame 12 is in the second position having a lower center of gravity than the first position (shown in FIGS. 2A to 2D). In the stroller configuration, a user may walk, jog, or run behind the stroller assembly 10, to propel the stroller assembly 10 and any occupant forward. In the trailer configuration, a user may attach the stroller (now functioning as a trailer) to the rear of a bicycle (or other vehicle), and may pull the trailer and any occupant forward, behind the bicycle (or other vehicle)

FIG. 2A is a conceptual perspective view of the convertible stroller assembly 10 of FIG. 1A in a trailer configuration 10a. FIG. 2B is a conceptual side view of the stroller assembly 10a of FIG. 2A. FIG. 2C is a front side view of the stroller assembly 10a of FIG. 2A. FIG. 2D is a top view of the stroller assembly 10a of FIG. 2A.

Beginning with the configuration 10 shown in FIGS. 1A to 1D, the seat frame 20 may be lowered to the second position (for example, after being removed from the stroller frame 12), and the front wheel 18 removed from the assembly stroller frame 12, to result in the configuration 10a. The removal of the front wheel 18 and the lowering of the seat frame 20 may be performed in any order. In some embodiments, the seat frame 20 is not removed from the stroller frame 12, and remains attached to the stroller frame 12 during the moving or lowering. For example, the seat frame 20 may be slid along the stroller frame 12. Vice versa, beginning with the configuration 10a shown in FIGS. 2A to 2D, the seat frame 20 may be raised to the first position, and the front wheel 18 coupled to the stroller frame 12, to result in the configuration 10a. The coupling of the front wheel 18 and the raising of the seat frame 20 may be performed in any order, and performed with or without removal of the seat frame 20 from the stroller frame 12.

The stroller frame 12 may include a number of frame portions or sub-assemblies. For example, the stroller frame 12 may include a rear frame assembly 22 coupled to the pair of laterally opposed hubs 14. In some embodiments, the plurality of wheels 16 includes at least two rear wheels coupled to the rear frame assembly 22. In some embodiments, the plurality of wheels 16 includes no more than two rear wheels coupled to the rear frame assembly 22. In some embodiments, the plurality of wheels 16 includes exactly two rear wheels coupled to the rear frame assembly 22 (and a single front wheel 18).

The seat frame 20 may be slidably coupled to the rear frame assembly 22, for example, being slidable along the rear frame assembly 22 toward and away from the pair of laterally opposed hubs 14 (in the direction of the double-headed dashed arrows shown in FIG. 1B. For example, the rear frame assembly 22 may define parallel rails or slots, and portions of the seat frame 20 may engage in the rails or slots to slide along the rails or slots.

In embodiments, the rear frame assembly 22 includes a rear axle 24 coupled between a pair of opposed rear bars 26. The at least two rear wheels may be coupled to the rear axle 24. Each rear bar of the pair of opposed rear bars 26 may defines a respective hub end 28 coupled to a respective hub of the pair of laterally opposed hubs 14 and a respective axle end 30 coupled to the rear axle 24. As seen in FIGS. 1A and 1B, each rear bar of the opposed rear bars 26 may be angled downward from a respective hub of the pair of laterally opposed hubs 14 to the rear axle 30.

The opposed rear bars 26 may ultimately support and sustain the seat frame 20 and any occupant. In some embodiments, each rear bar of the pair of opposed rear bars 26 defines a respective channel. The seat frame 20 may be slidably secured between and within the respective channels of the pair of opposed rear bars.

In embodiments, the stroller frame 12 includes an upper frame assembly 32 coupled to the pair of laterally opposed hubs 14. For example, the upper frame assembly 32 may extend upward and/or backward from the laterally opposed hubs 14. A user may hold or grip a portion of the upper frame assembly 32, for example, to direct the motion of the stroller assembly 10 in the stroller mode. The upper frame assembly 32 may also act as a truss to redistribute load or weight, and further support the lower frame assembly 22, and the stroller frame 12 as a whole.

In some embodiments, the upper frame assembly 32 includes a crossbar 34 coupled between a pair of opposed upper bars 36. In some such embodiments, each upper bar of the pair of opposed upper bars 36 defines a respective hub end 38 coupled to a respective hub of the pair of laterally opposed hubs and a respective crossbar end 40 coupled to the crossbar 34. In some embodiments, each upper bar of the opposed upper bars is angled upward from a respective hub of the pair of laterally opposed hubs 14 to the crossbar 34. The crossbar 34 may provide lateral support and stability to the upper assembly 32, and to the stroller frame 12 as a whole.

The crossbar 34 may also be used to couple or secure further components. For example, the assembly 10 may include a handle 42 coupled to the upper frame assembly 32. The handle 42 may include a u-shaped bar rotatably coupled to the crossbar 34.

In some embodiments, the assembly 10 further includes a fold lock assembly 44 coupled to the upper frame assembly 32. The fold lock assembly 44 resists a folding of the convertible stroller assembly 10 about the pair of laterally opposed hubs 14. The fold lock assembly 44 may include a button 46 configured to temporarily defeat the resistance to folding. For example, a cable, a chain, a pin, or some other mechanism that blocks folding of one or more portions of the stroller frame 12 about the hubs 14 may be ultimately mechanically coupled to the button 46, and pressing the button 46 may disengage the cable or pin, allowing folding to proceed.

In some embodiments, the assembly 10 further includes a canopy bar 48 secured to the stroller frame 12 or the seat frame 20. In some embodiments, the canopy bar 48 is secured to the seat frame 20, so that the canopy bar 48 slides with the seat frame. In some embodiments, the canopy bar 48 may be secured to both the stroller frame 12 and the seat frame 20. For example, as the seat frame 20 is moved, a portion or an end of the canopy bar 48 may move through a tube, channel, or slot through or along a portion of the stroller frame 12 (for example, within or along the rear bars 26). In some embodiments, the canopy bar 48 is secured to the seat frame 20 and is configured to move with the seat frame 20 relative to the stroller frame 12.

In the canopy bar 48 defines a u-shaped body extending upward from the stroller frame 12 or from the seat frame 20.

The canopy bar 48 may be rotatably or fixedly mounted relative to the hubs 14. For example, the canopy bar 48 may or may not be rotatable relative to the hubs 14. In some embodiments, the canopy bar 48 is rotatable about the hubs 14 only when the seat frame 20 is raised, and may be locked or unable to rotate about the hubs 14 when the seat frame 20 is lowered. For example, when the seat frame 20 is lowered, a portion of the canopy bar 48 may be drawn within another portion of the stroller frame 12, for example, into the rear bars 26, which may prevent a rotational movement of the remaining portion of the canopy bar 48.

While not shown in FIGS. 1A to 2D, it is understood that a fabric or liner may be secured to the canopy bar 48, thus forming a canopy. The fabric or liner may be intended to be removably coupled by the user, or may not be intended to be removed by the user. Accordingly, the fabric or liner may be removably or permanently secured to the canopy bar 48.

In some embodiments, the stroller frame 12 includes a front frame assembly 52 coupled to the pair of laterally opposed hubs 14. The front frame assembly 52 may facilitate distributing load or weight of an occupant along the stroller frame 12. The front frame assembly 52 may also facilitate folding of the assembly 10, for example, for storage or transport. For example, one or both of the front frame assembly 52 and the rear frame assembly 32 may be configured to rotate about the hubs 14 toward each other to ultimately fold the stroller assembly 10, and away from each other to unfold the stroller assembly.

One or more components may be coupled to the front frame assembly 52. For example, the front wheel 18 may be removably coupled to the front frame assembly 52. The front frame assembly 52 may further include a fork 54 to which the front wheel 18 may be removably coupled. For example, the fork 54 may define openings through which a front axle may be coupled, with the front wheel 18 rotatably coupled about the front axle. The front axle (or ultimately the wheel 18) may be removable from the fork 54 by the user.

In some embodiments, the front frame assembly 52 further comprises a front hub 56. The fork 54 may be coupled to the front hub 56. The front hub 56 may defining a hitch slot 58, and the hitch slot 58 may be configured to receive a hitch bar 60 (shown in FIGS. 2A to 2D). The hitch bar 60 may extend from a bicycle or another vehicle, and thus, may be used to secure the stroller assembly 10 in the trailer configuration 10a to the bicycle or vehicle.

In some embodiments, the front frame assembly 52 further includes a foot rest bar 62. In some such embodiments, the foot rest bar 62 may be coupled to the front hub 56, for example, rotatably coupled to the front hub 56. Thus, an occupant in the seat frame 20 may rest their feet against the foot rest bar 62.

Thus, stroller assemblies according to the disclosure may be convertible between a stroller mode or configuration and a trailer mode or configuration.

FIG. 3 is a conceptual perspective view of a stroller 100 including the convertible stroller assembly 10 of FIG. 1A in a stroller configuration. The stroller 100 includes a liner 70 secured to the assembly 10. The liner 10 may include a film, a fabric, a membrane, a shell, a netting, a web, a foam, a padding, or any other finishing or upholstery material or structure, or combinations thereof. The stroller 100 includes a seat 80 including a liner (which may be similar to the liner 70) secured to the seat assembly 20.

FIG. 4 is a conceptual perspective view of a trailer 100a including the convertible stroller assembly 10 of FIG. 1A in a trailer configuration 10a. As seen in FIG. 4, the front wheel 18 is absent (removed from the assembly 10), and the hitch bar 60 is coupled to the assembly 10, ready to be towed by a bicycle or a vehicle.

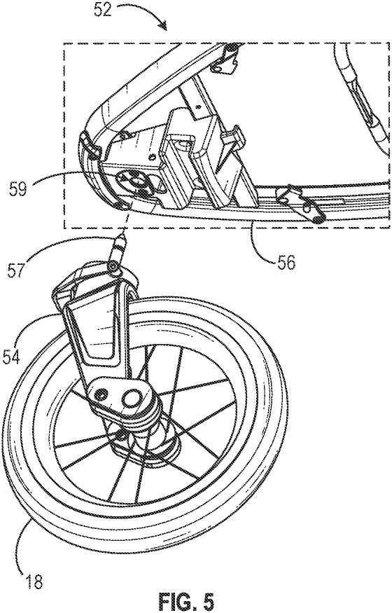

FIG. 5 is a bottom perspective view of a front frame assembly 52 of the stroller assembly of FIG. 1A. FIG. 5 shows that the front wheel 18 may also be removably coupled to the front frame assembly 52 using a pin 57. The pin 57 may be inserted into an aperture 59 in the front frame assembly 52 to removably secure the front wheel 18 to the front frame assembly 52. The pin 57 may be coupled to the fork 54 of the front wheel 18 such that when the pin 57 is removably secured within the aperture 59 the front wheel 18 is also removably secured to the front frame assembly 52.

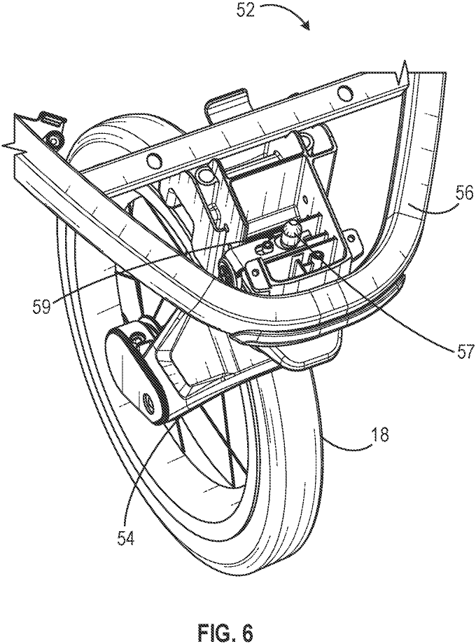

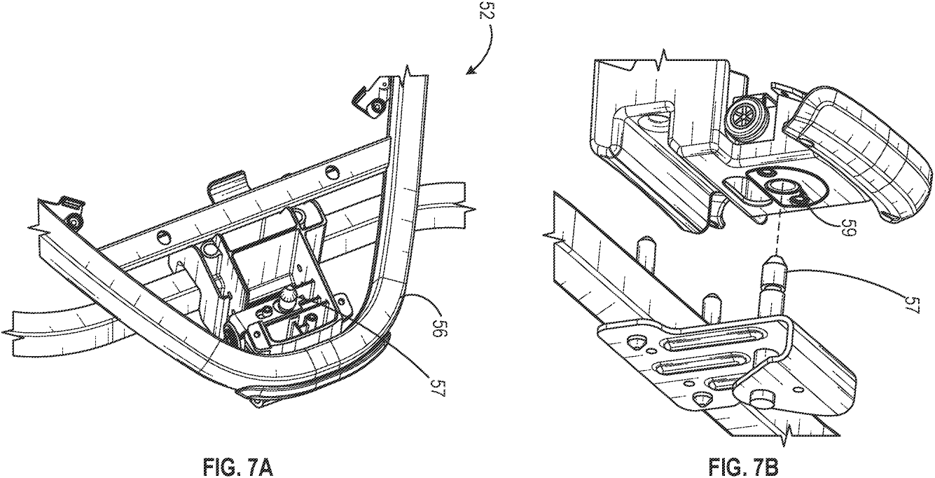

FIG. 6 is a top perspective view of the front frame assembly 52 of FIG. 5. FIG. 6 shows that the pin 57 is inaserted within the aperture 59 and the front wheel 18 is removably secured to the front frame assembly 52. FIG. 7A is another top perspective view of the front frame assembly 52 of FIG. 5 in which the pin 57 is provided within the aperture 59.

FIG. 7B is a perspective view of the front frame assembly 52 of FIG. 5 and the hatch bar 60. That is, the hitch bar 60 may similarly be removably secured to the front frame assembly 52 by providing the pin 57 on the hitch bar 60 into the aperture 59 of the front frame assembly 52. The pin 57 is advantageous in that it provides weight reduction and reduces structural complexity because the same mechanism may be used to attach the front wheel 18 and the hitch bar 60 to the front frame assembly 52.

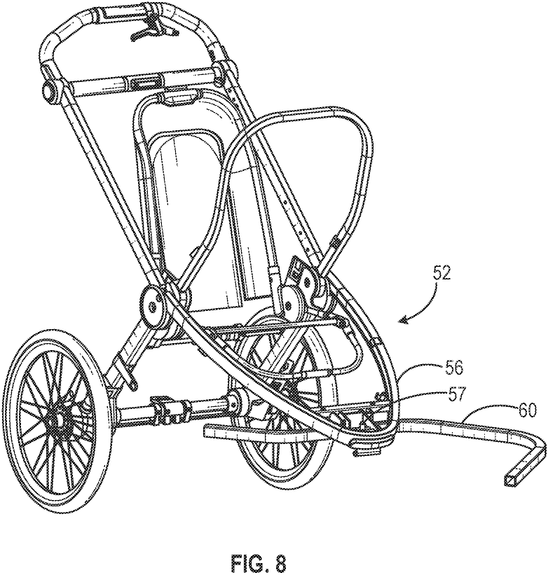

FIG. 8 is another conceptual perspective view of the convertible stroller assembly of FIG. 1A in a trailer configuration.

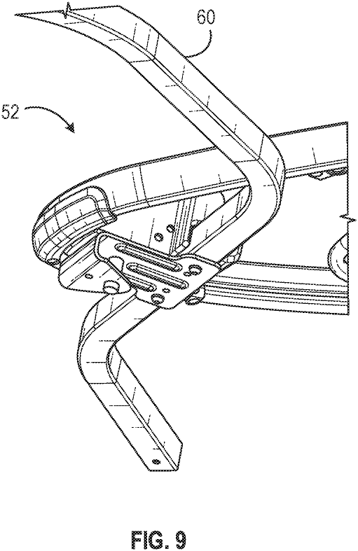

FIG. 9 is a bottom perspective view of a front frame assembly 52 of the stroller assembly of FIG. 5 in a trailer configuration. FIG. 9 illustrates the hatch bar 60 being removably secured to the front frame assembly 52 when the pin 57 is inserted into the aperture 59.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

Embodiment 1 may include a convertible stroller assembly comprising: a stroller frame comprising a pair of laterally opposed hubs; a plurality of wheels coupled to the stroller frame and comprising at least one removable front wheel; and a seat frame adjustably coupled to the stroller frame and being adjustable relative to the pair of laterally opposed hubs between a first position and a second position lower than the first position, wherein the convertible stroller assembly is convertible between (i) a stroller configuration in which the front wheel is coupled to the stroller frame and the seat frame is in the first position, and (ii) a trailer configuration in which the front wheel is absent and the seat frame is in the second position having a lower center of gravity than the first position.

Embodiment 2 may include Embodiment 1, wherein the stroller frame comprises a rear frame assembly coupled to the pair of laterally opposed hubs.

Embodiment 3 may include any one of Embodiments 1 to 2, wherein the seat frame is slidably coupled to the rear frame assembly and is slidable along the rear frame assembly toward and away from the pair of laterally opposed hubs.

Embodiment 4 may include any one of Embodiments 1 to 3, wherein the plurality of wheels comprises at least two rear wheels coupled to the rear frame assembly.

Embodiment 5 may include any one of Embodiments 1 to 4, wherein each hub of the pair of laterally opposed hubs is between the at least front wheel and the at least two rear wheels in a direction from the at least front wheel to the at least two rear wheels.

Embodiment 6 may include any one of Embodiments 1 to 5, wherein the rear frame assembly comprises a rear axle coupled between a pair of opposed rear bars, and wherein the at least two rear wheels are coupled to the rear axle.

Embodiment 7 may include any one of Embodiments 1 to 6, wherein each rear bar of the pair of opposed rear bars defines a respective hub end coupled to a respective hub of the pair of laterally opposed hubs and a respective axle end coupled to the rear axle.

Embodiment 8 may include any one of Embodiments 1 to 7, wherein each rear bar of the opposed rear bars is angled downward from a respective hub of the pair of laterally opposed hubs to the rear axle.

Embodiment 9 may include any one of Embodiments 1 to 8, wherein each rear bar of the pair of opposed rear bars defines a respective channel, and wherein the seat frame is slidably secured between and within the respective channels of the pair of opposed rear bars.

Embodiment 10 may include any one of Embodiments 1 to 9, wherein the stroller frame comprises an upper frame assembly coupled to the pair of laterally opposed hubs, and wherein the upper frame assembly comprises a crossbar coupled between a pair of opposed upper bars.

Embodiment 11 may include any one of Embodiments 1 to 10, wherein each upper bar of the pair of opposed upper bars defines a respective hub end coupled to a respective hub of the pair of laterally opposed hubs and a respective crossbar end coupled to the crossbar.

Embodiment 12 may include any one of Embodiments 1 to 11, wherein each upper bar of the opposed upper bars is angled upward from a respective hub of the pair of laterally opposed hubs to the crossbar.

Embodiment 13 may include any one of Embodiments 1 to 12, further comprising a fold lock assembly coupled to the upper frame assembly, wherein the fold lock assembly resists a folding of the convertible stroller assembly about the pair of laterally opposed hubs, and wherein the fold lock assembly comprises a button configured to temporarily defeat the resistance to folding.

Embodiment 14 may include any one of Embodiments 1 to 13, further comprising a canopy bar secured to the stroller frame or the seat frame.

Embodiment 15 may include any one of Embodiments 1 to 14, wherein the canopy bar defines a u-shaped body extending upward from the stroller frame or from the seat frame.

Embodiment 16 may include any one of Embodiments 1 to 14, wherein the canopy bar is secured to the seat frame and is configured to move with the seat frame relative to the stroller frame.

Embodiment 17 may include any one of Embodiments 1 to 16, further comprising a front frame assembly coupled to the pair of laterally opposed hubs.

Embodiment 18 may include any one of Embodiments 1 to 17, wherein the at least one front wheel is removably coupled to the front frame assembly.

Embodiment 19 may include any one of Embodiments 1 to 18, wherein the front frame assembly is foldable relative to the rear frame assembly about the pair of laterally opposed hubs.

Embodiment 20 may include any one of Embodiments 1 to 19, wherein the front frame assembly further comprises a front hub defining a hitch slot, wherein the hitch slot is configured to receive a hitch bar.

Embodiment 21 may include any one of Embodiments 1 to 20, wherein the front frame assembly further comprises a foot rest bar.

Embodiment 22 may include any one of Embodiments 1 to 21, further comprising at least one finishing material coupled to at least a portion of the convertible stroller assembly, wherein the finishing material comprises at least one of a liner, a foam, a netting, a web, a fabric, or a padding.

What is claimed is:

1. A convertible stroller assembly comprising:
a stroller frame comprising a pair of laterally opposed hubs;
a plurality of wheels coupled to the stroller frame and comprising at least one removable front wheel; and
a seat frame adjustably coupled to the stroller frame and being adjustable relative to the pair of laterally opposed hubs between a first position and a second position lower than the first position,
wherein the convertible stroller assembly is convertible between (i) a stroller configuration in which the front wheel is coupled to the stroller frame and the seat frame is in the first position, and (ii) a trailer configuration in which the front wheel is absent and the seat frame is in the second position having a lower center of gravity than the first position.

2. The convertible stroller assembly of claim 1, wherein the stroller frame comprises a rear frame assembly coupled to the pair of laterally opposed hubs.

3. The convertible stroller assembly of claim 2, wherein the seat frame is slidably coupled to the rear frame assembly and is slidable along the rear frame assembly toward and away from the pair of laterally opposed hubs.

4. The convertible stroller assembly of claim 2, wherein the plurality of wheels comprises at least two rear wheels coupled to the rear frame assembly.

5. The convertible stroller assembly of claim 4, wherein each hub of the pair of laterally opposed hubs is between the at least front wheel and the at least two rear wheels in a direction from the at least front wheel to the at least two rear wheels.

6. The convertible stroller assembly of claim 5, wherein each hub of the pair of laterally opposed hubs is offset from a geometric center between the at least front wheel and the at least two rear wheels in a direction toward the at least two rear wheels.

7. The convertible stroller assembly of claim 6, wherein the rear frame assembly comprises a rear axle coupled between a pair of opposed rear bars, and wherein the at least two rear wheels are coupled to the rear axle.

8. The convertible stroller assembly of claim 7, wherein each rear bar of the pair of opposed rear bars defines a respective hub end coupled to a respective hub of the pair of laterally opposed hubs and a respective axle end coupled to the rear axle.

9. The convertible stroller assembly of claim 8, wherein each rear bar of the opposed rear bars is angled downward from a respective hub of the pair of laterally opposed hubs to the rear axle.

10. The convertible stroller assembly of claim 9, wherein each rear bar of the pair of opposed rear bars defines a respective channel, and wherein the seat frame is slidably secured between and within the respective channels of the pair of opposed rear bars.

11. The convertible stroller assembly of claim 1, wherein the stroller frame comprises an upper frame assembly coupled to the pair of laterally opposed hubs, and wherein the upper frame assembly comprises a crossbar coupled between a pair of opposed upper bars.

12. The convertible stroller assembly of claim 11, wherein each upper bar of the pair of opposed upper bars defines a respective hub end coupled to a respective hub of the pair of laterally opposed hubs and a respective crossbar end coupled to the crossbar.

13. The convertible stroller assembly of claim 12, wherein each upper bar of the opposed upper bars is angled upward from a respective hub of the pair of laterally opposed hubs to the crossbar.

14. The convertible stroller assembly of claim 13, further comprising a fold lock assembly coupled to the upper frame assembly, wherein the fold lock assembly resists a folding of the convertible stroller assembly about the pair of laterally opposed hubs, and wherein the fold lock assembly comprises a button configured to temporarily defeat the resistance to folding.

15. The convertible stroller assembly of claim 1, further comprising a canopy bar secured to the stroller frame or the seat frame.

16. The convertible stroller assembly of claim 15, wherein the canopy bar defines a u-shaped body extending upward from the stroller frame or from the seat frame, and wherein the canopy bar is secured to the seat frame and is configured to move with the seat frame relative to the stroller frame.

17. The convertible stroller assembly of claim 1, further comprising a front frame assembly coupled to the pair of laterally opposed hubs.

18. The convertible stroller assembly of claim 17, wherein the front frame assembly further comprises a front hub defining a hitch slot, wherein the hitch slot is configured to receive a hitch bar.

19. The convertible stroller assembly of claim 18, wherein the front frame assembly further comprises a foot rest bar.

20. The convertible stroller assembly of claim 19, further comprising at least one finishing material coupled to at least a portion of the convertible stroller assembly, wherein the finishing material comprises at least one of a liner, a foam, a netting, a web, a fabric, or a padding.
